(19) United States
(12) Patent Application Publication
(10) Pub. No.: US 2025/0128587 A1
(43) Pub. Date: Apr. 24, 2025

(54) Propel

(71) Applicant: General William Carson, JR., McDoungh, GA (US)

(72) Inventor: General William Carson, JR., McDoungh, GA (US)

(21) Appl. No.: 18/445,570

(22) Filed: Oct. 23, 2023

(51) Int. Cl. B60J 11/04

(52) U.S. Cl. CPC B60J 11/04

(57) ABSTRACT

AN INFLATABLE CAR COVER DESIGNED TO PROTECT VEHICLES FROM ENVIRONMENTAL ELEMENTS. THE INFLATABLE CAR COVER COMPRISES AN INFLATABLE STRUCTURE CONFIGURED TO FIT OVER A VEHICLE BY AN AIR PUMP MECHANISM FOR INFLATING THE STRUCTURE, THE COVER CAN BE EASILY INSTALLED AND REMOVED, PROVIDING CONVENIENCE AND EFFICIENCY FOR USERS.

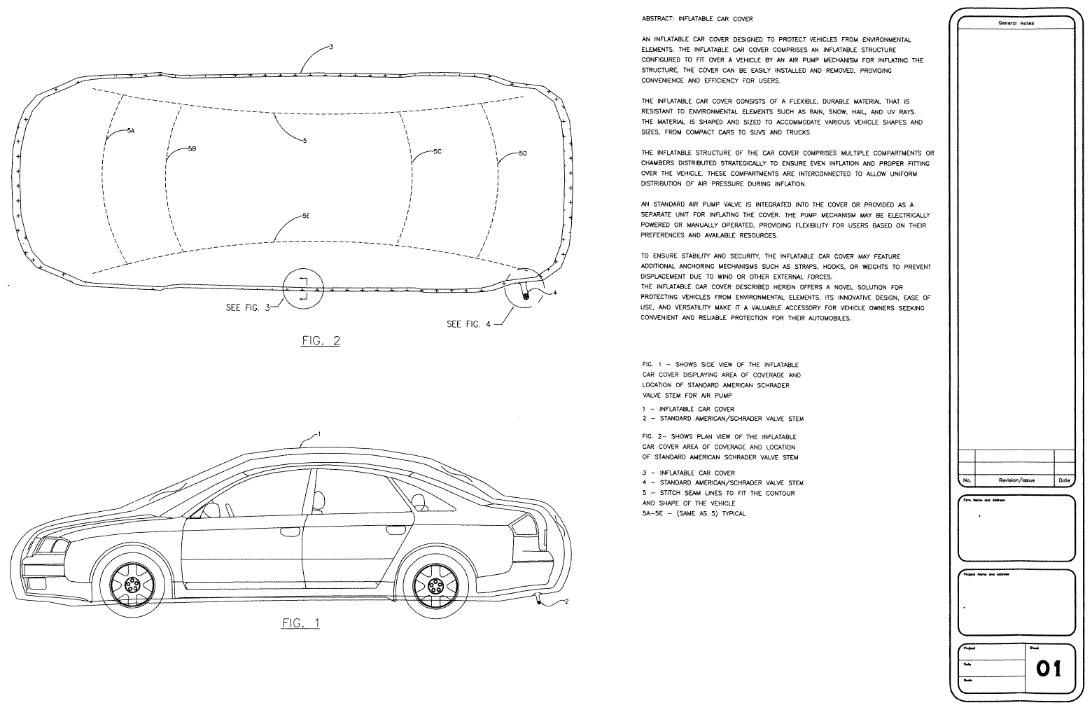

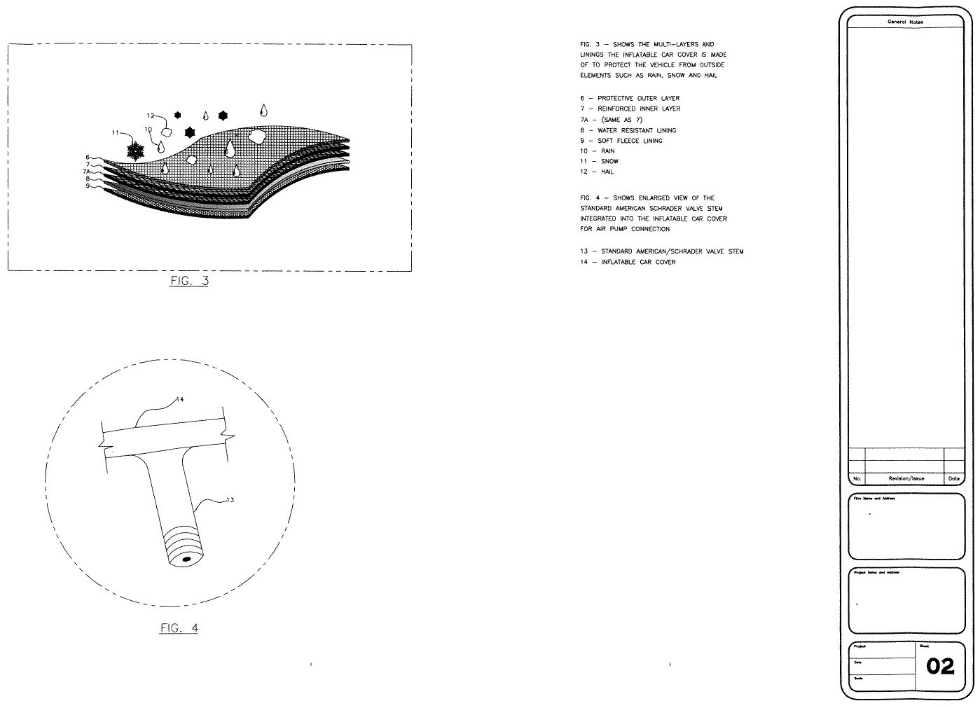

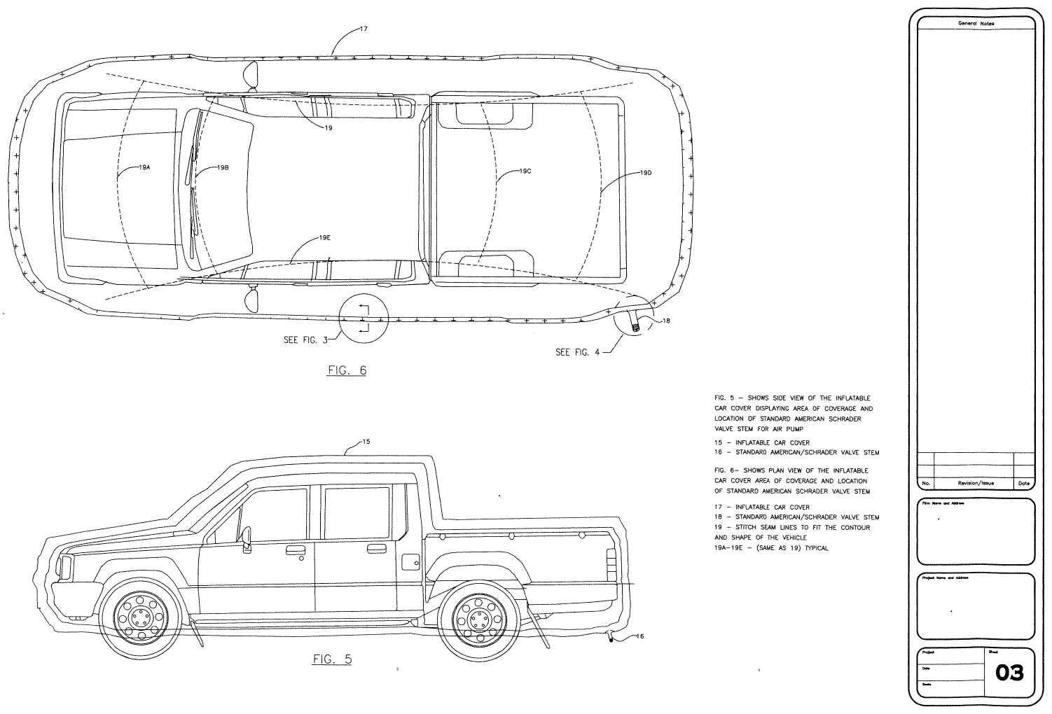

THE INFLATABLE CAR COVER CONSISTS OF A FLEXIBLE, DURABLE MATERIAL THAT IS RESISTANT TO ENVIRONMENTAL ELEMENTS SUCH AS RAIN, SNOW, HAIL, AND UV RAYS.

THE MATERIAL IS SHAPED AND SIZED TO ACCOMMODATE VARIOUS VEHICLE SHAPES AND SIZES, FROM COMPACT CARS TO SUVS AND TRUCKS.

THE INFLATABLE STRUCTURE OF THE CAR COVER COMPRISES MULTIPLE COMPARTMENTS OR CHAMBERS DISTRIBUTED STRATEGICALLY TO ENSURE EVEN INFLATION AND PROPER FITTING OVER THE VEHICLE. THESE COMPARTMENTS ARE INTERCONNECTED TO ALLOW UNIFORM DISTRIBUTION OF AIR PRESSURE DURING INFLATION.

AN STANDARD AIR PUMP VALVE IS INTEGRATED INTO THE COVER OR PROVIDED AS A SEPARATE UNIT FOR INFLATING THE COVER. THE PUMP MECHANISM MAY BE ELECTRICALLY POWERED OR MANUALLY OPERATED, PROVIDING FLEXIBILITY FOR USERS BASED ON THEIR PREFERENCES AND AVAILABLE RESOURCES.

TO ENSURE STABILITY AND SECURITY, THE INFLATABLE CAR COVER MAY FEATURE ADDITIONAL ANCHORING MECHANISMS SUCH AS STRAPS, HOOKS, OR WEIGHTS TO PREVENT DISPLACEMENT DUE TO WIND OR OTHER EXTERNAL FORCES.

THE INFLATABLE CAR COVER DESCRIBED HEREIN OFFERS A NOVEL SOLUTION FOR PROTECTING VEHICLES FROM ENVIRONMENTAL ELEMENTS. ITS INNOVATIVE DESIGN, EASE OF USE, AND VERSATILITY MAKE IT A VALUABLE ACCESSORY FOR VEHICLE OWNERS SEEKING CONVENIENT AND RELIABLE PROTECTION FOR THEIR AUTOMOBILES.

This cover will protect cars and trucks from being damaged from FOD (foreign object Debris). This cover will consist of an inflatable tubbing (micro thin inner tube lining with air stem) that will become inflatable using the standard air pump that come with most new vehicles and trucks. You can also pump up the cover with many battery chargers that comes with air pumps functionally. This car\truck cover can be used in all types of weather conditions. Hale, Tornado, Winds Storms, and Yard Maintenance.

The design of the inflatable inner tube lining with air stem will in the same shape as any standard car or truck cover, less 2 inches all the way around the bottom seam of the cover.
1) The inflatable tubing will have an air stem on the front driver's side bottom where the tire is located on any vehicle.
2) Removal, the cover will be removed by simply pressing the inner pin on the air stem to deflate the car\truck cover.
3) The Propel car and truck cover will fold up and be place in its protected carry bag.

1: A VEHICLE PROTECTIVE COVER COMPRISING:
A DURABLE OUTER LAYER MADE OF WEATHER-RESISTANT MATERIAL CAPABLE OF WITHSTANDING EXPOSURE TO UV RADIATION, RAIN, SNOW, DUST, AND POLLUTANTS, WHEREIN SAID OUTER LAYER IS SELECTED FROM THE GROUP CONSISTING OF POLYESTER, POLYPROPYLENE, VINYL, AND SPECIALIZED FABRICS.
AN INNER LINING CONSTRUCTED FROM SOFT, NON-ABRASIVE MATERIAL TO PREVENT SCRATCHING OR MARRING OF THE VEHICLE'S SURFACE.
REINFORCED SEAMS AND EDGES TO ENHANCE DURABILITY AND LONGEVITY OF THE COVER DURING PROLONGED OUTDOOR USE;
ELASTICIZED HEMS AND ADJUSTABLE STRAPS FOR SECURING THE COVER SNUGLY AROUND THE VEHICLE'S CONTOURS, MINIMIZING THE RISK OF DISPLACEMENT DUE TO WIND OR INCLEMENT WEATHER CONDITIONS.
INTEGRATED LOCKING MECHANISMS OR PROVISION FOR PADLOCKS TO DETER THEFT AND UNAUTHORIZED REMOVAL OF THE COVER FROM THE VEHICLE.

2: THE VEHICLE PROTECTIVE COVER OF CLAIM 1, WHEREIN THE OUTER LAYER FURTHER COMPRISES A WATER-RESISTANT COATING OR TREATMENT TO REPEL MOISTURE AND PREVENT WATER PENETRATION, THEREBY SAFEGUARDING THE VEHICLE FROM RUST, CORROSION, AND MOLD GROWTH.

3: THE VEHICLE PROTECTIVE COVER OF CLAIM 1, WHEREIN THE INNER LINING IS COMPOSED OF A MICROFIBER OR FLEECE MATERIAL TO PROVIDE GENTLE CUSHIONING AND PREVENT ABRASION AGAINST THE VEHICLE'S PAINTWORK AND FINISH.

4: THE VEHICLE PROTECTIVE COVER OF CLAIM 1, WHEREIN THE REINFORCED SEAMS AND EDGES ARE REINFORCED WITH DOUBLE STITCHING OR HEAT-SEALED SEAMS TO PREVENT FRAYING AND UNRAVELING OVER TIME.

5: THE VEHICLE PROTECTIVE COVER OF CLAIM 1, FURTHER COMPRISING REFLECTIVE STRIPS OR PANELS STRATEGICALLY POSITIONED FOR INCREASED VISIBILITY DURING LOW-LIGHT CONDITIONS, ENHANCING THE SAFETY AND VISIBILITY OF THE COVERED VEHICLE.

6: THE VEHICLE PROTECTIVE COVER OF CLAIM 1, WHEREIN THE ELASTICIZED HEMS AND ADJUSTABLE STRAPS ARE DESIGNED TO ACCOMMODATE VARIOUS VEHICLE SHAPES AND SIZES, ENSURING A SECURE AND CUSTOMIZED FIT FOR DIFFERENT MAKES AND MODELS.

7: THE VEHICLE PROTECTIVE COVER OF CLAIM 1, WHEREIN THE LOCKING MECHANISMS ARE INTEGRATED INTO THE COVER'S DESIGN, PROVIDING A SEAMLESS AND TAMPER-RESISTANT SOLUTION FOR SECURING THE COVER TO THE VEHICLE.

8: THE VEHICLE PROTECTIVE COVER OF CLAIM 1, WHEREIN THE PROVISION FOR PADLOCKS INCLUDES REINFORCED GROMMETS OR LOOPS STRATEGICALLY POSITIONED ALONG THE PERIMETER OF THE COVER, ALLOWING USERS TO SECURELY FASTEN PADLOCKS OR CABLE LOCKS TO PREVENT UNAUTHORIZED ACCESS.

9: THE VEHICLE PROTECTIVE COVER OF CLAIM 1, FURTHER COMPRISING VENTILATION PANELS OR MESH INSERTS TO PROMOTE AIR CIRCULATION AND PREVENT CONDENSATION BUILDUP UNDERNEATH THE COVER, THEREBY REDUCING THE RISK OF MOLD, MILDEW, AND MUSTY ODORS INSIDE THE VEHICLE.
